(19) United States
(12) Patent Application Publication
(10) Pub. No.: US 2008/0096593 A1
(43) Pub. Date: Apr. 24, 2008

(54) SHORT MESSAGE COMPOSITION METHOD

(75) Inventor: Ga Hee PARK, Daegu-city (KR)

Correspondence Address: Jefferson IP Law, LLP, 1730 M Street, NW, Suite 807, Washington, DC, 20036, US

(73) Assignee: Samsung Electronics Co., LTD, Suwon-city (KR)

(21) Appl. No.: 11/774,288

(22) Filed: Jul. 6, 2007

(30) Foreign Application Priority Data
Oct. 18, 2006 (KR) 2006-010314

(51) Int. Cl. H04Q 7/20

(52) U.S. Cl. 455/466

(57) ABSTRACT

A short message composition method for a mobile terminal is provided for easily referring to a received message while writing a reply message. The message composition method includes opening a reply message composition window in response to a command for writing a reply message in response to a received message, determining whether a message review request is input, and opening, if a message review request is input, a review window for presenting the received message while the reply message composition window is activated. The short message composition method of the present invention is advantageous since a received message can be accessed without closing a reply message on writing and complex key manipulation. Also, the short message composition of the present invention allows a user to refer to a reference message, i.e. a received message, while writing a reply message such that the reply message can be wrote in a high reliability.

### PRIORITY

This application claims the benefit under 35 U.S.C. §119(a) of a Korean patent application filed on Oct. 18, 2006 in the Korean Intellectual Property Office and assigned Serial No. 2006-0101314, the entire disclosure of which is hereby incorporated by reference.

### BACKGROUND OF THE INVENTION

1. Field of the Invention

The present invention relates to a mobile terminal. More particularly, the present invention relates to a short message composition method for a mobile terminal that enables easily accessing a reference message while writing a reply message.

2. Description of the Related Art

A Short Message Service (SMS) has achieved a huge success in the wireless communication field, and recently has been developed in the form of Enhanced Messaging Service (EMS) and Multimedia Messaging Service (MMS).

In order for a user to reply to a received message, a mobile terminal provides a reply message composition interface such that the user can easily set up a reply message composition mode. In the reply message composition mode, the mobile terminal automatically designates a phone number from which the original message is received as a recipient's phone number. The reply message composition mode is provided to be selected when a short message is received such that the user can activate the reply mode upon receiving the short message.

When the mobile terminal operates in a message composition mode, a message composition window is presented on a display screen of the mobile terminal.

Meanwhile, a user may need to be reminded of a content of the received message while writing a reply message. For example, the received message may contain information, such as a long serial number, to be referenced.

In the conventional mobile terminal, however, there is no way to refer to the received message in the reply message composition mode. In order to refer to the content of the received message, it is required to access the received message after saving a draft reply message and then reopen the draft reply message for completing the reply message.

Accordingly, the conventional message composition method is disadvantageous with cumbersome key manipulation for referring to the content of the received message while writing a reply message, resulting in user inconvenience.

### SUMMARY OF THE INVENTION

An aspect of the present invention is to address at least the above problems and/or disadvantages and to provide at least the advantages described below. Accordingly, an aspect of the present invention is to provide a short message composition method for a mobile terminal that enables accessing a reference message while writing a reply message without closing a draft reply message.

Another aspect of the present invention is to provide a short message composition method that enables quickly referring to a reference message, resulting in composition of a reliable reply message.

In accordance with an aspect of the present invention, a message composition method for a mobile terminal is provided. The message composition method includes opening a reply message composition window in response to a command for writing a reply message in response to a received message, determining whether a message review request is input, and opening, if a message review request is input, a review window for presenting the received message while the reply message composition window is activated.

In accordance with another aspect of the present invention, a message composition method for a mobile terminal is provided. The message composition method includes opening a reply message composition screen having a first window and a second window in response to a command for writing a reply message in response to a received message, presenting the received message in the first window, and presenting the reply message on writing in the second window.

### BRIEF DESCRIPTION OF THE DRAWINGS

The above and other aspects, features and advantages of certain exemplary embodiments of the present invention will be more apparent from the following detailed description in conjunction with the accompanying drawings, in which:

FIG. 1 is a block diagram illustrating a configuration of a mobile terminal adopted a short message composition method according to an exemplary embodiment of the present invention;

FIG. 2 is a flowchart illustrating a short message composition method according to an exemplary embodiment of the present invention;

FIGS. 3 to 8 are screen images illustrating steps of the short message composition method of FIG. 2;

FIG. 9 is a flowchart illustrating a short message composition method according to another exemplary embodiment of the present invention;

FIG. 10 is a flowchart illustrating a reference message display process of the short message composition method of FIG. 9;

FIGS. 11 and 12 are screen images illustrating steps of the short message composition method of FIG. 9;

FIG. 13 is a flowchart illustrating a short message composition method according to another exemplary embodiment of the present invention;

FIGS. 14, 15A, and 15B are screen images illustrating steps of the short message composition method of FIG. 13; and

FIGS. 16A to 16D are screen images illustrating steps of setting up a reply message composition mode of a short message composition method according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of the exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions may be omitted for clarity and conciseness.

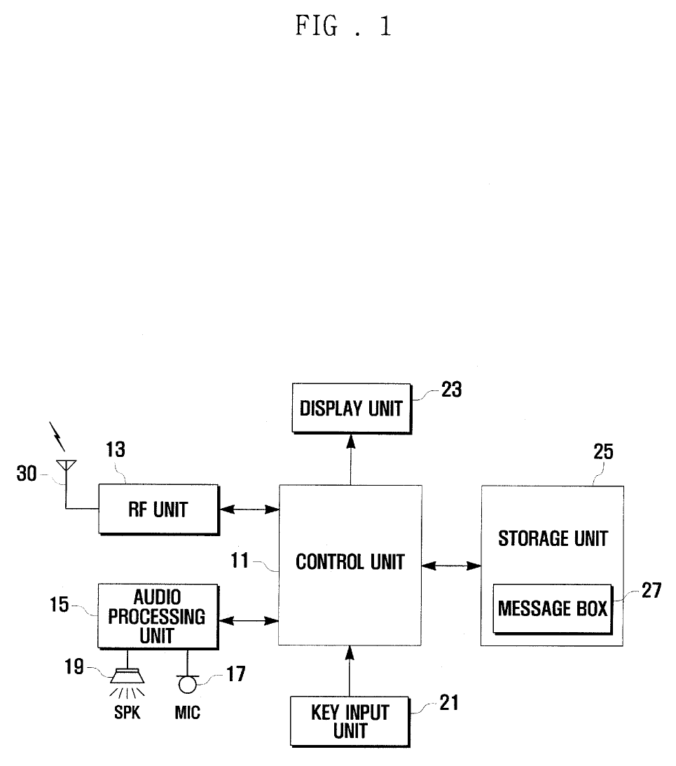

FIG. 1 is a block diagram illustrating a configuration of a mobile terminal adopted a short message composition method according to an exemplary embodiment of the present invention.

Referring to FIG. 1, the mobile terminal includes a control unit 11, a radio frequency (RF) unit 13, an audio processing unit 15, a microphone 17, a speaker 19, a key input unit 21, a display unit 23, a storage unit 25, and an antenna 30.

The RF unit 13 down-converts radio signals received through the antenna 30 and up-converts signals to be transmitted into radio signals.

The audio processing unit 15 processes an audio signal received through a communication channel so as to be output through the speaker 19 in the form of an audible sound wave and processes an audio signal input through the microphone 17 so as to be transmitted in the form of digital signal.

The storage unit 25 stores various programs, such as an operating system and various application programs, and application data generated while the programs operate. Particularly, the storage unit 25 is provided with a message box 27 for storing short messages. The short messages include received messages, sent messages, draft messages, reserved messages and the like.

The display unit 23 displays various application screens for presenting execution status and guiding a user's manipulation. For example, the display unit 23 displays an SMS application screen for presenting an SMS message in response to the user's manipulation.

The key input unit 21 is provided with a plurality of alphanumeric and function keys for generating user commands.

The control unit 11 controls general operations of the mobile terminal. Particularly, the control unit 11 controls such that a received text message is displayed on the display unit 23 and stored in the message box 27.

An operation of the above-structured mobile terminal is described hereinafter in association with the short message composition. In an exemplary embodiment, a received message is stored in the message box 27 and called to be displayed on the display unit 23 while writing a reply message in response to the received message. The reply message composition can be allowed while the received message is displayed at the first view. The reply message can be composed in the form of an SMS, EMS, or MMS message.

In this exemplary embodiment, the term “selection” is used for implying an execution of a function by the control unit in response to a key manipulation.

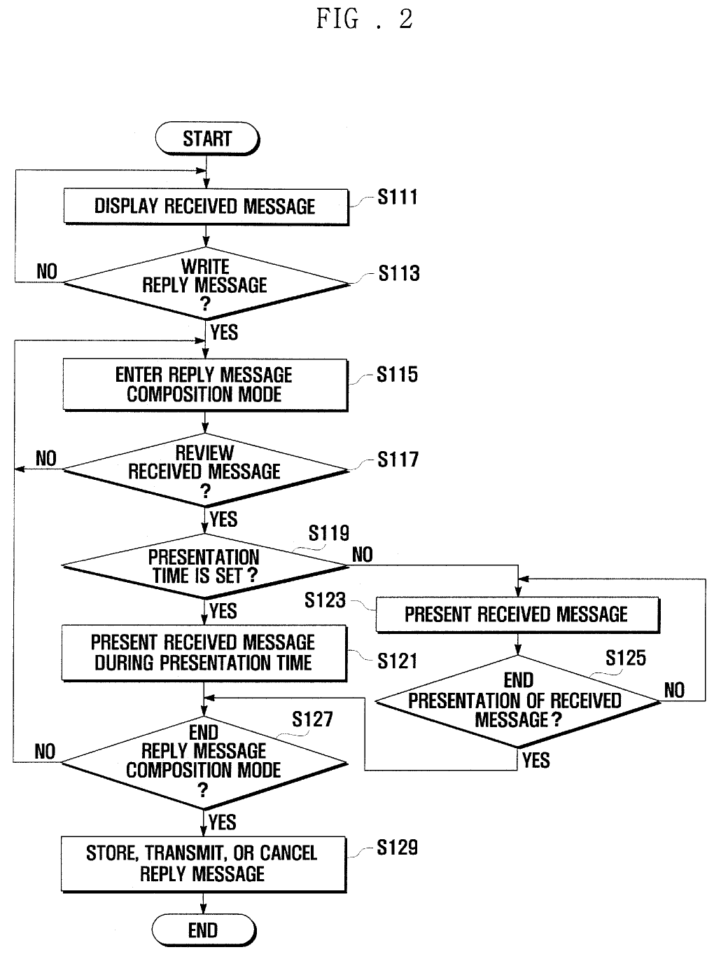

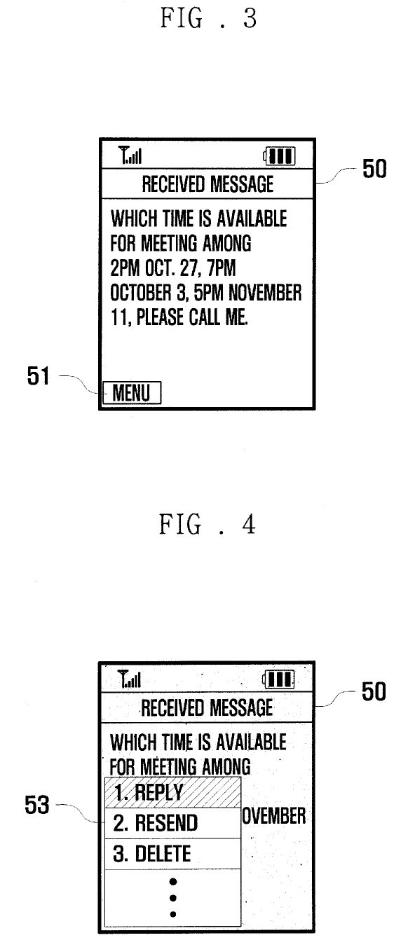

FIG. 2 is a flowchart illustrating a short message composition method according to an exemplary embodiment of the present invention, and FIGS. 3 to 8 are screen images for illustrating steps of the short message composition method of FIG. 2.

Referring to FIGS. 1 and 2, if a short message is received, the control unit 11 stores the received message into the message box 27 and displays the received message on the display unit 23 at step S111. The received message is displayed on a received message screen 50 as shown in FIG. 3. The received message screen 50 is provided with a received message menu button 51 such that a user can navigate and select an option on a menu window opened when the received message menu button 51 is selected.

If a key is input for selecting the received message menu button 51, the control unit 11 detects the key input and displays a received message menu window 53 for providing a plurality of options as shown in FIG. 4. In FIG. 4, the received message menu window 53 lists options of “reply”, “resend”, “delete”, etc.

Accordingly, the user can select an option presented on the received message menu screen 53 by manipulating navigation, OK, and number keys on the key input unit 21. In an exemplary embodiment, the key input unit 21 is provided with a soft key for selecting the menu button 51 and the received message menu window 53 may be opened by clicking the soft key. In another exemplary embodiment, the options are provided with index numbers and an option can be selected by clicking a number key corresponding to the option.

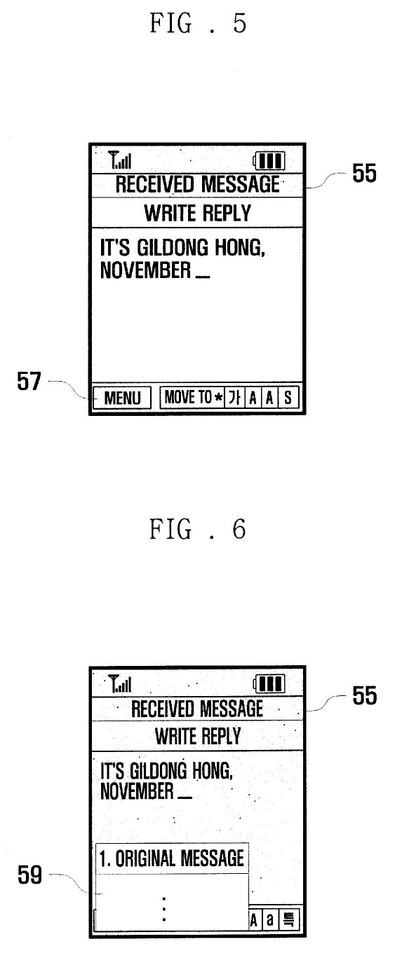

While the received message menu window 53 is presented, the control unit 11 determines whether a key is input for selecting a “reply” option at step S113. If a reply option key input is detected, the control unit 11 displays a reply message composition screen 55 on the display unit 23 as shown in FIG. 5 such that the user writes a reply message on the reply message composition screen 55 at step S115. The reply message composition screen 55 is provided with a reply message menu button 57 such that a user can navigate and select an option on a reply message menu window opened when the menu button 57 is selected.

If a key is input for selecting the reply message menu button 57, the control unit 11 detects the key input and displays a reply message menu window 59 providing a plurality of options as shown in FIG. 6. In FIG. 6, the reply message menu window 59 lists options.

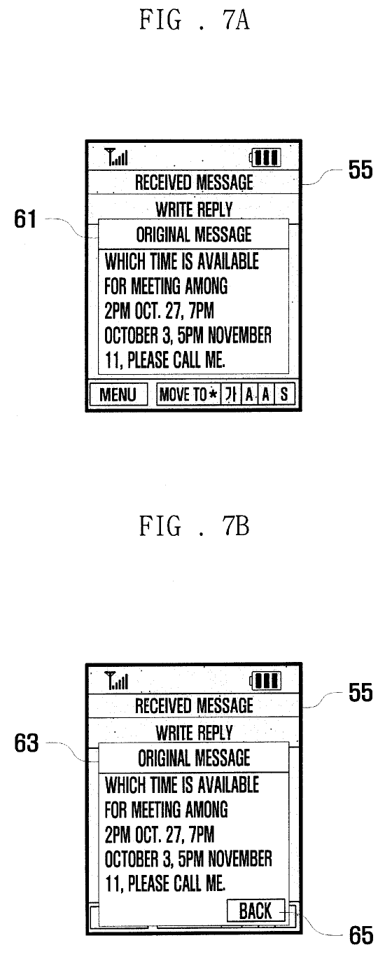

While the reply message composition screen 55 is presented, the control unit 11 determines whether a key is input for checking the received message at step S117. If a received message check key input is detected, the control unit 11 determines whether a display time is set up at step S119. If a display time is set up, the control unit 11 displays the received message during the display time at step S121. As shown in FIG. 7A, the received message is presented in the form of a popup window 61 on the reply message composition screen 55. When the entire received message cannot be presented on the popup window 61 at one time, the control unit 11 controls such that the received message scrolls down. The popup window 61 disappears when the display time ends. The content of the received message can be displayed in the reply message composition screen 55 or displayed in a separate partial or entire display window.

If a display time is not set up, the control unit 11 displays the received message in the form of a popup window 63 as shown in FIG. 7B at step S123. The popup window 63 is provided with a “back” button 65 for closing the popup window 63.

Accordingly, while the popup window 63 is opened, the control unit 11 determines whether a key is input for selecting the back button 65 at step S125. If a key input for selecting the back button 65 is detected, the control unit 11 closes the popup window 63.

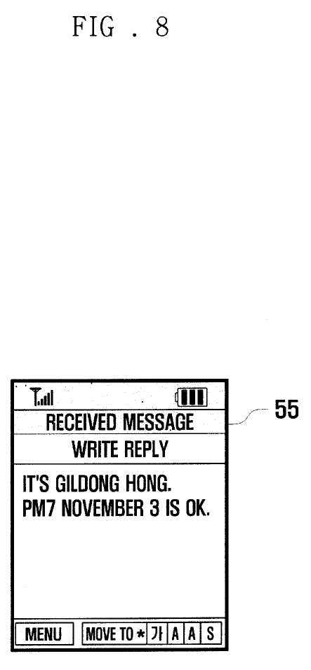

After the popup window 61 or 63 is closed, the display unit 11 determines whether a key is input for ending the reply message composition mode at step S127. If a key is input for ending the reply message composition mode, the control unit 11 controls to return to step S115. That is, control unit 11 displays the reply message composition screen 55 to maintain writing the reply message such that the user can complete writing the reply message as shown in FIG. 8. If a key is input for ending the reply message composition mode, the control unit 11 saves, transmits, or cancels the reply message in response to a command input through the key input unit at step S129.

As described above, the short message composition method according to an exemplary embodiment of the present invention enables the user to refer to an original message without closing a reply message composition screen, whereby the user can composes the reply message quickly with reliable content.

Also, the short message composition method according to an exemplary embodiment of the present invention presents the original message to be replied during a preset time periodically. In this case, there is no need for a key manipulation to return to the reply message composition screen. Also, an original message window can be set to appear during the reply message composition mode session such that the user can refer to the original message until completing the reply message composition.

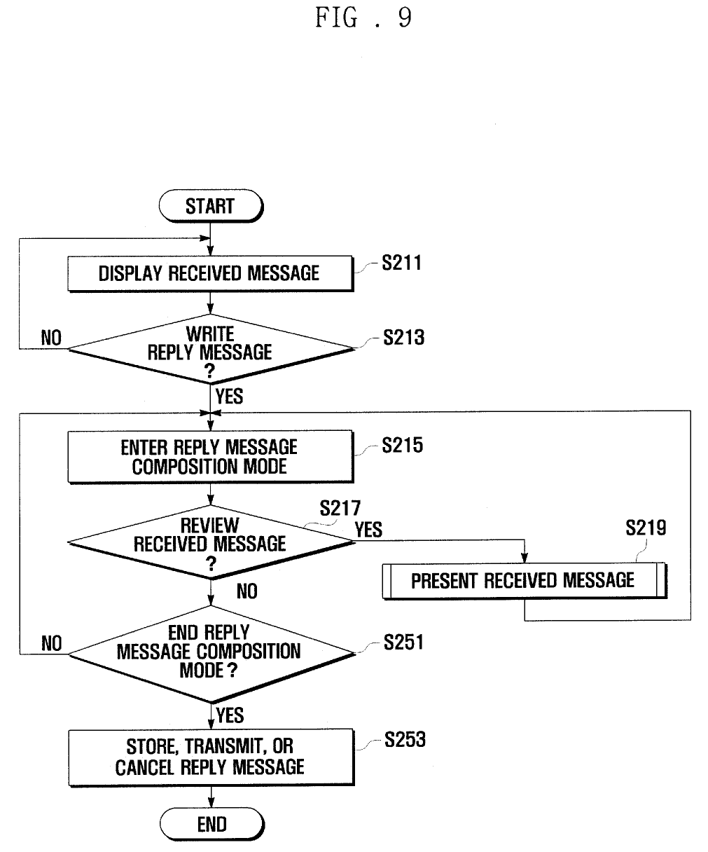

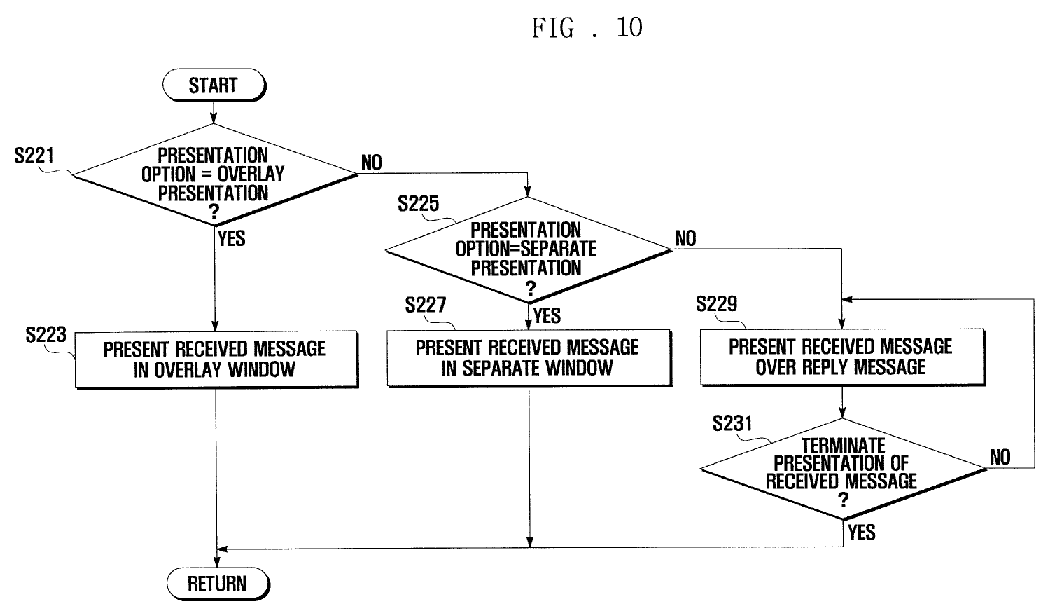

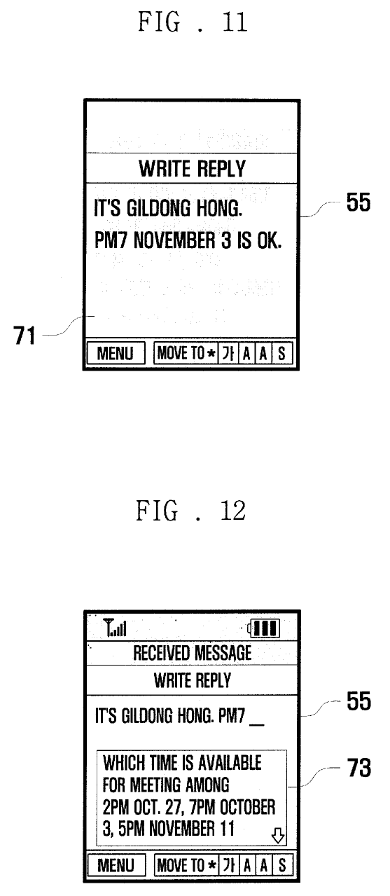

FIG. 9 is a flowchart illustrating a short message composition method according to another exemplary embodiment of the present invention, FIG. 10 is a flowchart illustrating a reference message display process of the short message composition method of FIG. 9, and FIGS. 11 and 12 are screen images illustrating steps of the exemplary short message composition method of FIG. 9.

Referring to FIGS. 1 and 9, if a short message is received, the control unit 11 stores the received message into the message box 27 and displays the received message on the display unit 23 at step S211. Next, the control unit 11 determines whether a key is input for entering a reply message composition mode at step S213. If a key is input for entering a reply message composition mode, the control unit 11 controls to enter a reply message composition mode and display a reply message composition screen at step S215. While the mobile terminal operates in the reply message composition mode, the control unit 11 determines whether a key is input for presenting a reference message at step S217. If a key input for presenting a reference message is detected, the control unit 11 presents the reference message at step S219.

The reference message presentation procedure is described in more detail with reference to FIG. 10. Referring to FIG. 10, if the key input for presenting a reference message is detected, the control unit 11 determines whether a reference message presentation option is set for an overlay presentation at step S221. If the reference message presentation option is set for an overlay presentation, the control unit 11 displays the reference message on the reply message composition screen in the form of an overlay window at step S223. The overlay reference message window 71 is displayed in a preset transparent level such that the reply message composition screen 55 is presented through the overlay reference message window 71 as a background. Accordingly, the user can see the content of the reply message when writing it and while checking the reference message. The reference message is extracted from the received message and displayed in the form of a partial window or a full window.

If the reference message presentation option is not set for an overlay presentation, the control unit 11 determines whether the reference message presentation option is set for a separate presentation at step S225. If the reference message presentation option is set for a separate presentation, the control unit 11 presents the reference message in the form of a separate window 73 at one side of the reply message composition screen 55 as shown in FIG. 12 at step S227. In FIG. 12, the separate reference message window 73 is arranged at a bottom of the reply message composition screen 55 as an example. The control unit 11 can control such that the separate reference message window 73 does not cover the content of the reply message on writing.

If the reference message presentation option is not set for a separate presentation, the control unit 11 displays the reference message over the content of the reply message composition screen 55 as in the previous exemplary embodiment at step S229. Next, the control unit 11 determines whether a key is input for terminating the presentation of the reference message at step S231. The reference message is presented until the key input for terminating the reference message is detected. In another exemplary embodiment, the reference message presentation can be set to disappear in a preset time. After the reference message has disappeared, the control unit 11 repeats step S215 in order for the user to continue writing the reply message. In the case of the overlay presentation or separate presentation mode, the control unit 11 controls such that the user can continue writing while the reference message window is opened. Accordingly, the user can write the reply message while viewing the reference message.

Returning to FIG. 9, if a key input for presenting a reference message is not detected at step S217, the control unit 11 determines whether a key is input for ending the reply message composition mode at step S251. If a key input for ending the reply message composition mode is detected, the control unit 11 ends the reply message composition mode, and saves, transmits, or cancels the reply message in response to a user command at step S253.

As described above, the short message composition method according to another exemplary embodiment of the present invention enables writing a reply message while viewing a content of a reference message, i.e. a received message. Although the reference message presentation options are selected in an order of the overlay presentation and the separate presentation, the selected options can be changed.

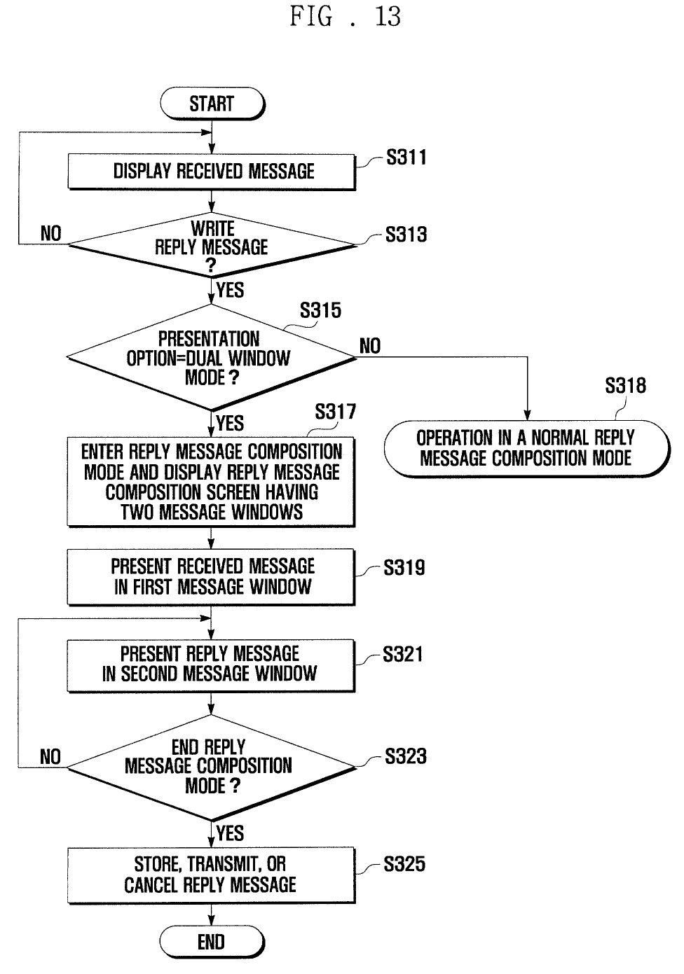

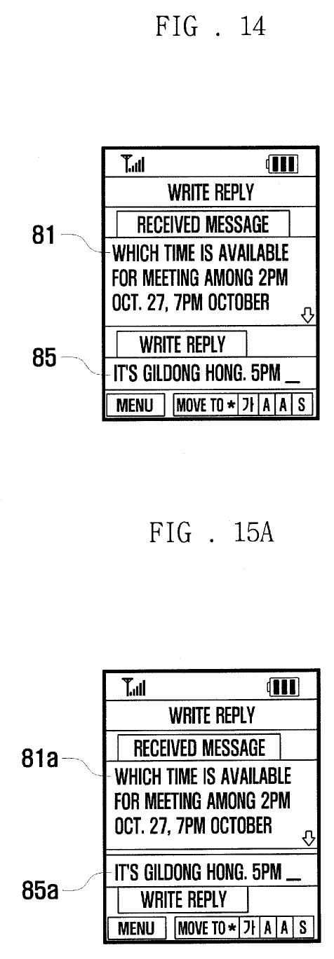

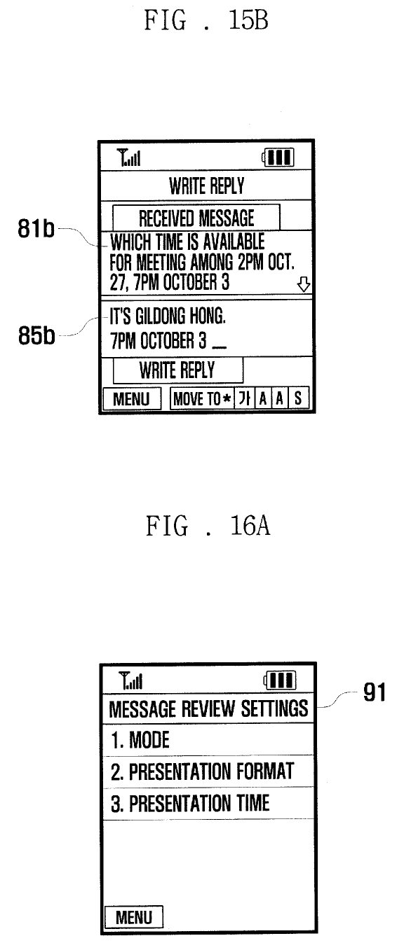

FIG. 13 is a flowchart illustrating a short message composition method according to another exemplary embodiment of the present invention, and FIGS. 14, 15A, and 15B are screen images illustrating steps of the short message composition method of FIG. 13.

In this exemplary embodiment, the received message is presented upon the mobile terminal entering the reply message composition mode unlike the previous exemplary embodiments.

Referring to FIGS. 1 and 13, if a short message is received, the control unit 11 stores the received message into the message box 27 and displays the received message on the display unit 23 at step S311. Next, the control unit 11 determines whether a key is input for entering a reply message composition mode at step S313. If a key input for entering a reply message composition mode is detected, the control unit 11 determines whether a display option of the reply message composition mode is set for a dual window mode at step S315. If the display option is not set for a dual window mode, the control unit 11 controls the mobile terminal to operate in a normal reply message composition mode at step S318.

If the display option is set for a dual window mode, the control unit 11 controls the mobile terminal to enter the reply message composition mode and display a reply message composition screen having two message windows on the display unit 23 at step S317. Next, the control unit 11 controls to present the received message in a first message window at step S319. The first message window is implemented to scroll up and down the received message. Next, the control unit 11 controls to present a reply message on writing in a second message window at step S321. Accordingly, the user can write the reply message while viewing the received message.

The reply message composition screen can be configured as shown in FIG. 14. In FIG. 14, the reply message composition screen has a first message window 81 for presenting the received message and a second window 85 for presenting the reply message on writing, the first and second message windows being vertically arranged.

The first message window 81 is controlled such that the received message is automatically scrolled down when the received message is too long to be presented at one time. Also, the message can be performed automatically or manually.

A size of the second message window 85 can be fixed such that only a single line of the message is presented. Also, the second message window 85 can be implemented such that its size may be automatically adjusted in accordance with the variation of length of the reply message on writing. The window size can be adjusted in association with a number of the lines of the reply message. That is, the control unit 11 increases or decreases the size of the second message window 85 in proportion of the number of the lines of the reply message on writing. The second window may have a limit size.

FIGS. 15A and 15B show the reply message composition screens before and after a line of the reply message increases. In FIG. 15A, the second message window 85a has a size enough for presenting a single line of the reply message. As shown in FIG. 15B, as the line of the reply message is changed, the size of the second message increases such that two lines of the reply message 85b on writing can displayed. Of course, if the number of the lines decreases, the second message window shrinks enough to present the reply message on writing.

Returning to FIG. 13, after displaying the reply message in the second message window at step S321, the control unit 11 determines whether a key is input for ending the reply message composition mode at step S323. If a key input for ending the reply message composition mode is detected, the control unit 11 ends the reply message composition mode and saves, transmits, or cancels the reply message in response to a user command at step S325.

As described above, the short message composition method according to another exemplary embodiment of the present invention enables presenting a received message and a reply message on writing at the same time in order for the user to write the reply message while viewing the received message.

The reference message presentation can be configured on an option menu screen presented when mobile terminal enters the reply message composition mode.

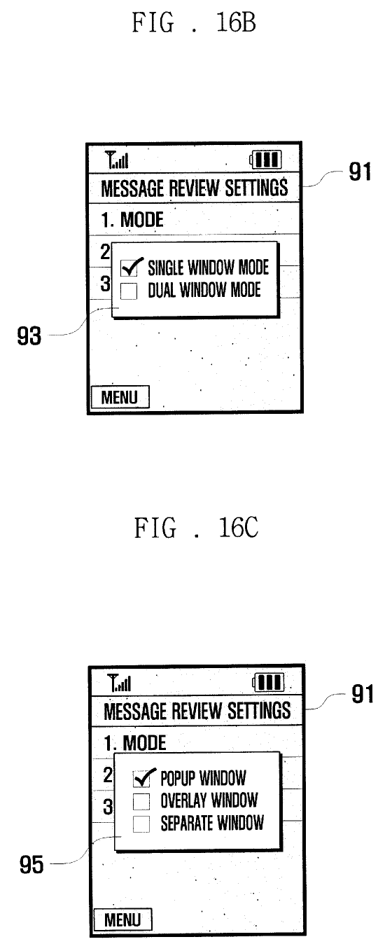

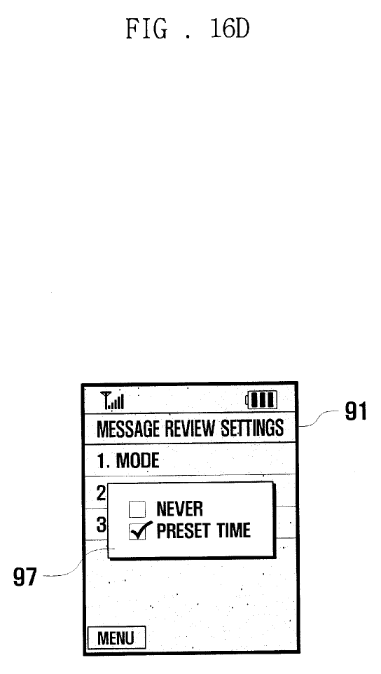

FIGS. 16A to 16D are screen images illustrating steps of setting up a reply message composition mode of a short message composition method according to an exemplary embodiment of the present invention.

If a reference message review option is selected from a menu screen, a reference message review setting screen 91 is presented. The reference message review setting screen 91 provides a mode selection, display format, display time option items and the like.

If the mode selection option is selected, a mode selection window is popped up as shown in FIG. 16B. The mode selection window provides a single window and dual window options with check boxes such that the user can select one of the single and dual window options by selecting a corresponding check box. The single window option is associated with an exemplary embodiment of the present invention, and the dual window option is associated with another exemplary embodiment.

If the display format option is selected, a display format selection window 95 is popped up as shown in FIG. 16C. The display format selection window provides a popup window, overlay window, and separate window options. If the display time option is selected, a display time selection window 97 is popped up as shown in FIG. 16D. The display time selection window provides a never and preset time options. Using such option windows, a user can set up detailed configuration of the reply message composition mode.

While the present invention has been shown and described in detail with reference to certain exemplary embodiments thereof, it should be clearly understood by those skilled in the art that many variations and/or modifications of the basic inventive concepts in form and details may be made therein without departing from the spirit and scope of the present invention, as defined in the appended claims and their equivalents.

As described above, the short message composition method of the present invention is advantageous since a received message can be accessed without closing a reply message on writing and complex key manipulation.

Also, the short message composition method of the present invention allows a user to refer to a reference message, i.e. a received message, while writing a reply message such that the reply message can be wrote in a high reliability.

What is claimed is:

1. A message composition method for a mobile terminal, comprising:
opening a reply message composition window in response to a command for writing a reply message in response to a received message;
determining whether a message review request is input; and
opening, if a message review request is input, a review window for presenting the received message while the reply message composition window is activated.

2. The message composition method of claim 1, further comprising closing the review window when a present event occurs.

3. The message composition method of claim 2, wherein the present event occurs at a preset time.

4. The message composition method of claim 2, wherein the present event comprises a key input for terminating presentation of the review window.

5. The message composition method of claim 1, wherein the review window comprises a popup window.

6. The message composition method of claim 1, wherein the review window comprises at least one of an overlay presentation mode, a separate presentation mode, and an over-reply message mode.

7. The message composition method of claim 5, wherein the received message is scrolled up and down in the popup window.

8. The message composition method of claim 1, wherein the review window comprises at least one of an overlay window, a separate window, and an over-reply message window.

9. The message composition method of claim 8, wherein the overlay window is presented in the form of a transparent layer having a predetermined transparence level.

10. The message composition method of claim 1, wherein the review window comprises a fixed window arranged at a side of the reply message composition window.

11. The message composition method of claim 1, further comprising saving the received message in a message box.

12. A message composition method for a mobile terminal, comprising:
opening a reply message composition screen having a first window and a second window in response to a command for writing a reply message in response to a received message; and
presenting the received message in the first window; and
presenting the reply message on writing in the second window.

13. The message composition method of claim 12, wherein the received message is scrolled up and down in the first window.

14. The message composition method of claim 12, wherein the second window is adjusted in size in proportion to a number of lines of the reply message on writing.

15. A method for setting up a reply message composition mode in mobile terminal, comprising:
selecting at least one of a single window mode and a dual window mode;
selecting at least one of a popup window, an overlay window and a separate window; and
determining if a present time is set.
